(19) United States
(12) Patent Application Publication
(10) Pub. No.: US 2024/0319856 A1
(43) Pub. Date: Sep. 26, 2024

(54) AUTOMATICALLY ADDING LOGOS TO ONLINE MEETINGS

(71) Applicant: Cisco Technology, Inc., San Jose, CA (US)

(72) Inventors: Qiujun Zhao, Hangzhou City (CN); Shujun Han, Shanghai (CN)

(21) Appl. No.: 18/187,226

(22) Filed: Mar. 21, 2023

(51) Int. Cl. G06F 3/04842

(52) U.S. Cl. CPC G06F 3/04842; H04L 65/1089; H04L 65/403

(57) ABSTRACT

A method is provided for adding graphical elements to content during an online meeting. A plurality of domain names are identified from email addresses associated with participants of an online meeting and a plurality graphical elements associated with the plurality of domain names are obtained. At least one graphical element of the plurality of graphical elements is associated with each domain name of the plurality of domain names. A selection of one or more graphical elements of the plurality of graphical elements is received and the one or more graphical elements are added to content for display during the online meeting.

### TECHNICAL FIELD

The present disclosure relates to online video meetings/conferences.

### BACKGROUND

Currently, a host or co-host of an online meeting can add a logo from a company or enterprise to content in the online meeting. However, online meetings may include participants from more than one company or enterprise. Finding two or more logos for the companies and uploading the logos for display in the online meeting is a tedious and time-consuming task for users.

### BRIEF DESCRIPTION OF THE DRAWINGS

FIG. 1 is a block diagram of an online video conference/meeting system configured to support obtaining and displaying two or more logos in an online meeting, according to an example embodiment.

FIGS. 2A and 2B show results of performing an image search for graphical elements associated with domain names, according to an example embodiment.

FIG. 3 shows a user interface depicting an example in which graphical elements associated with domain names are displayed in a stage manager panel, according to an example embodiment.

FIG. 4 shows a user interface depicting an example in which an option to add graphical elements to a stage during an online meeting is selected, according to an example embodiment.

FIG. 5 shows a user interface depicting an example in which an option to add graphical elements to video feeds during an online meeting is selected, according to an example embodiment.

FIG. 6 is a flow diagram illustrating a method of obtaining and displaying two or more logos in an online meeting, according to an example embodiment.

FIG. 7 is a hardware block diagram of a device that may be configured to perform the endpoint device-based operations involved in obtaining and displaying two or more logos during an online meeting, according to an example embodiment.

FIG. 8 is a hardware diagram of a computer device that may be configured to perform the meeting server operations involved in obtaining and displaying two or more logos during an online meeting, according to an example embodiment.

### DETAILED DESCRIPTION

### Overview

In one embodiment, a method is provided for facilitating adding two or more logos (brand-identifiers associated with an organization or enterprise) to content during an online meeting. The method includes identifying a plurality of domain names from email addresses associated with participants of an online meeting; obtaining a plurality graphical elements associated with the plurality of domain names, a graphical element of the plurality of graphical elements being associated with each domain name of the plurality of domain names; receiving a selection of one or more graphical elements of the plurality of graphical elements; and adding the one or more graphical elements to content for display during the online meeting.

### Example Embodiments

Online communication sessions may include participants from two or more different companies or organizations. For example, a meeting or webinar may be organized or sponsored by two or more companies/organizations. In some cases, it may be beneficial to display graphical images that serve as a brand-identifier for an organization or enterprise, such as logos, associated with the companies/organizations on content during an online communication session. For example, the logos may be displayed on the background or video feeds of participants associated with the companies/organizations. However, it is time consuming to locate several or many logo images corresponding to the companies/organizations and upload the logos to a stage manager. In addition, it may be tedious to match a company's logo to a participant for displaying the logo in the participant's video feed, particularly when many participants from different companies/organizations are participating in the meeting.

Embodiments described herein provide for improved acquisition and presentation of logos in content of an online meeting. According to embodiments described herein, when an online communication session begins, a meeting client associated with a host or co-host of the online communication session automatically parses email addresses of participants to identify domain names of companies/organizations (sometimes referred to herein as enterprises) associated with the participants. Images of logos corresponding to the different enterprises are automatically obtained. For example, an image search may be performed to obtain the logos. As another example, the logos may be obtained from official websites corresponding to the different enterprises. In one embodiment, several logos may be obtained for each domain name/enterprise. The images of the logos may be automatically downloaded and displayed on a stage manager panel associated with the host/co-host.

According to some embodiments, the host/co-host may select one or more of the logos to add to content displayed during the online communication session. For example, the host/co-host may select one of the downloaded logos for each identified enterprise. The host/co-host may additionally select a location to display the logo(s) in the content (e.g., in a background/stage view, in video feeds associated with the participants, etc.). The host/co-host may synchronize the stage for all participants so the participants of the online communication session may view the logo(s) added to the content in the location selected by the host.

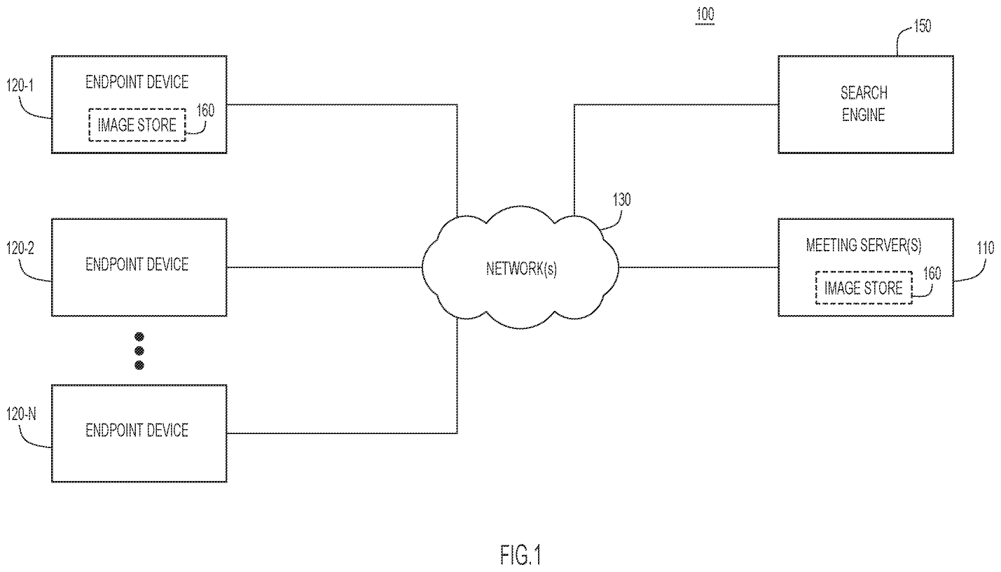

Reference is first made to FIG. 1. FIG. 1 shows a block diagram of a system 100 that is configured to add enterprise logos to content during an online communication session. The system 100 includes one or more meeting server(s) 110, a plurality of endpoint devices 120-1 to 120-N (sometimes referred to herein individually as endpoint device 120 or collectively as endpoint devices 120), and a search engine 150. The endpoint devices 120, meeting server(s) 110, and search engine 150 communicate via one or more networks 130. The meeting server(s) 110 are configured to provide an online meeting service for hosting a communication session among endpoint devices 120-1, 120-2, to 120-N. The meeting server(s) 110 includes an image store 160. Image store 160 is a data store for storing graphical elements associated with enterprises. In some embodiments, one or more of the endpoint devices 120-1 to 120-N (e.g., an endpoint device 120 associated with a host of an online meeting) may include an image store 160 for storing graphical elements associated with enterprises, as illustrated by the dashed lines around the image store 160 in endpoint device 120-1.

Each of endpoint devices 120-1 to 120-N may be a tablet, laptop computer, desktop computer, Smartphone, virtual desktop client, virtual whiteboard, or any user device now known or hereinafter developed. Endpoint devices 120-1 to 120-N may have a dedicated physical keyboard or touch-screen capabilities to provide a virtual on-screen keyboard to enter text. Endpoint devices 120-1 to 120-N may also have short-range wireless system connectivity (such as Bluetooth™ wireless system capability, ultrasound communication capability, etc.) to enable local wireless connectivity with a video endpoint device in a meeting room or with other user devices in the same meeting room. Endpoint devices 120-1 to 120-N may store content (e.g., a presentation, a document, images, etc.) for sharing the content with other user devices during an online meeting or communication session. In some embodiments, endpoint devices 120-1 to 120-N may be endpoint devices for facilitating communication with meeting server(s) 110 during the online meeting. Endpoint devices 120-1 to 120-N may additionally connect to user devices (not illustrated in FIG. 1) for sharing content stored on the user devices during the online meeting.

In some cases, endpoint devices 120-1 to 120-N may be videoconference endpoints designed for personal use (e.g., a desk device used by a single user) or for use by multiple users (e.g., a videoconference endpoint in a meeting room). In some embodiments, endpoint devices 120-1 to 120-N may be configured to open content to display or share (e.g., when a digital whiteboard is accessed directly on endpoint device 120).

In the example illustrated in FIG. 1, a user (e.g., a meeting coordinator, host, or co-host) of endpoint device 120-1 may schedule an online communication session (e.g., a meeting or webinar) and invite participants to attend the online communication session. The host may invite participants by sending invitation emails to the participants' email addresses. For example, the host may send invitations to Participant 1 at participant1@companya.com, Participant 2 at participant2@companyb.com, Participant 3 at participant3@companya.com, Participant 4 at participant4@companyb.com, Participant 5 at participant5@companya.com, and Participant 6 at participant6@companyb.com to attend the online communication session. In this example, Participant 1, Participant 3, and Participant 5 work at or are associated with Company A and Participant 2, Participant 4, and Participant 6 work at or are associated with Company B. Although this example includes participants from two enterprises, participants in the online communication session may be associated with any number of enterprises that may be identified from email addresses of the participants.

The host may determine to add graphical elements associated with Company A and Company B to content displayed during the online communication session. As used herein, a graphical element is an image associated with an enterprise, company, or organization, such as a logo, brand symbol, stylized text, or graphic indicative of or associated with the enterprise, company, or organization.

To obtain graphical images associated with the enterprises, domain names of the enterprises associated with the participants are identified. In one embodiment, the domain names may be automatically identified based on the host selecting an option, such as an option to display the graphical elements associated with the enterprises. In another embodiment, the domain names may be automatically identified when the online communication session begins. For example, a meeting client associated with the host's endpoint device (e.g., endpoint device 120-1) or meeting server(s) 110 may automatically parse the email addresses of the invited participants to identify domain names of enterprises associated with the participants. In the above example, the domain names companya.com and companyb.com are identified from the participants' email addresses. The domain names companya.com and companyb.com are identified as the domain names corresponding to Company A and Company B, respectively.

One or more graphical elements associated with each of the identified domain names may be automatically obtained. For example, the meeting client associated with endpoint device 120-1 or the meeting server(s) 110 may automatically obtain graphical elements associated with Company A and Company B. The meeting client associated with endpoint device 120-1 or the meeting server(s) 110 may automatically obtain the graphical elements without a request from a host or other participant.

In one embodiment, the meeting client associated with endpoint device 120-1 or the meeting server(s) 110 may perform an image search to obtain the graphical elements associated with Company A and Company B. For example, the meeting client associated with endpoint device 120-1 or the meeting server(s) 110 may access an application programming interface (API) associated with search engine 150 to perform the image search. The meeting client associated with endpoint device 120-1 or the meeting server(s) 110 may automatically determine a search term for performing the search without input from the host or other participant. For example, the meeting client associated with endpoint device 120-1 or the meeting server(s) 110 may automatically perform a search using the name of an enterprise (e.g., Company A or Company B) and, for example, the word “logo.” Other search terms may be used for obtaining graphical elements associated with the enterprises.

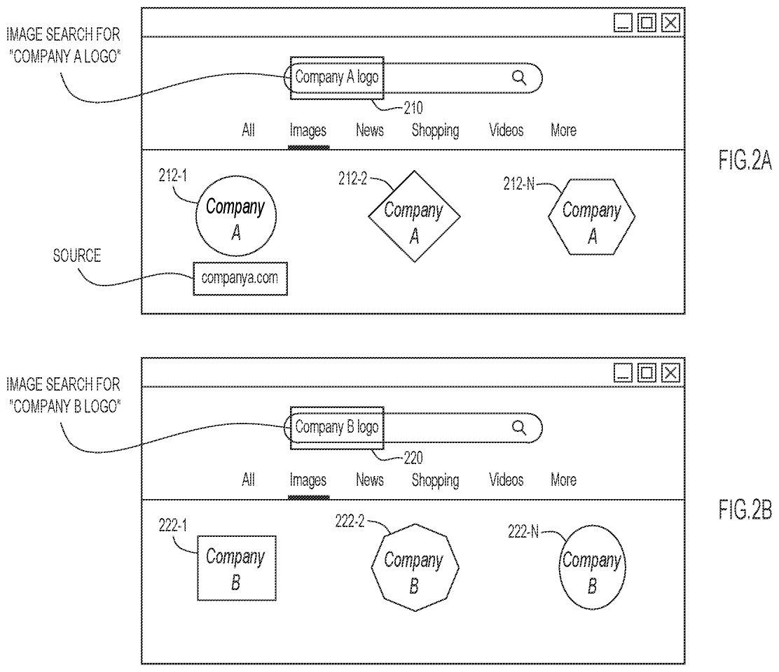

Reference is now made to FIGS. 2A and 2B. FIG. 2A illustrates an example image search for “Company A logo” and FIG. 2B illustrates an example image search for “Company B logo.”

As illustrated at 210 of FIG. 2A, an image search has been performed for “Company A logo” using, for example, search engine 150. Search results 212-1, 212-2, . . . , 212-N have been returned based on the search input “Company A logo.” Search results 212-1 to 212-N are graphical elements associated with Company A and illustrate different stylized text of the name Company A or images associated with Company A. In this example, search result 212-1 has a source of companya.com and the graphical element illustrated in search result 212-1 has been obtained from Company A's official website, www.companya.com.

Similarly, as illustrated at 220 of FIG. B, an image search has been performed for “Company B logo” using, for example, search engine 150. Search results 222-1, 222-2, . . . , 222-N have been returned based on the search input “Company B logo.” Search results 222-1 to 222-N are graphical elements associated with Company B and illustrate different stylized text of the name Company B or images associated with Company B.

Returning to FIG. 1, in another embodiment, the graphical elements associated with the enterprises may be obtained from the official websites associated with the enterprises. For example, the meeting client associated with endpoint device 120-1 or the meeting server(s) 110 may obtain one or more graphical elements associated with the domain name companya.com from an official website associated with Company A (e.g., www.companya.com) and may obtain one or more graphical elements associated with the domain name companyb.com from an official website associated with Company B (e.g., www.companyb.com).

A configurable number (e.g., three, five, etc.) of graphical elements associated with each domain name may be automatically downloaded and displayed on a stage manager panel associated with the host or co-host. The graphical elements may be grouped by domain name. In some cases, when an image search has been performed to obtain the graphical elements, a disclaimer may be displayed before downloading the images to indicate that one or more images may have copyright issues. If the host does not agree to the disclaimer, the graphical elements obtained from the image search are not downloaded to the stage manager panel. In this case, the graphical elements may be obtained from the official websites associated with the domain names (e.g., www.companya.com and www.companyb.com).

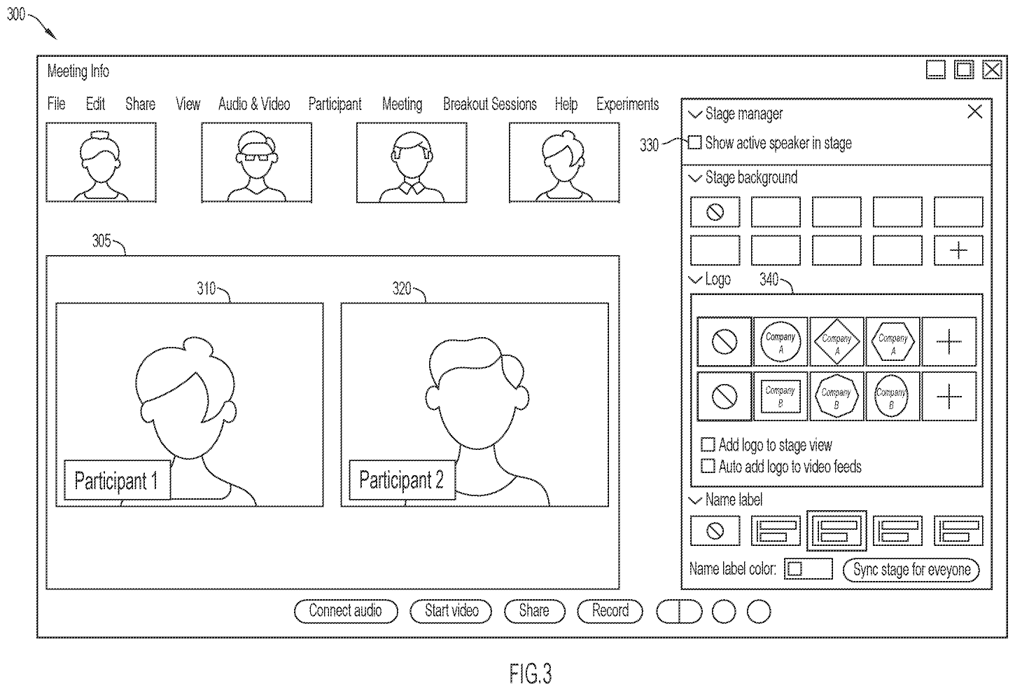

Reference is now made to FIG. 3. FIG. 3 illustrates a user interface 300 associated with a host of an online communication session. User interface 300 includes a stage 305 and stage manager panel 340. As illustrated in FIG. 3, the host has unchecked the “Show active speaker in stage” box 330 and stage 305 includes video feeds 310 and 320. For example, the host may have moved video feeds 310 and 320 to the stage 305. In this example, video feed 310 is the video feed for Participant 1 (participant1@companya.com) and video feed 320 is the video feed for Participant 2 (participant2@companyb.com).

In the example illustrated in FIG. 3, three graphical elements have been downloaded to the stage manager panel 340 for each domain name. Although this example shows three graphical elements downloaded, the number of graphical elements downloaded for each domain name is configurable. For example, the host may configure the number of graphical elements downloaded for each domain name. For Company A, the stage manager panel 340 shows an option of displaying no graphical element or displaying one of the three downloaded graphical elements corresponding to Company A. Similarly, for Company B, the stage manager panel 340 shows an option of displaying no graphical element or displaying one of the three downloaded graphical elements corresponding to Company B. In the stage manager panel 340 illustrated in FIG. 3, the option to display no graphical element is selected for Company A and Company B. Therefore, no graphical images are displayed on the stage 305 or on video feeds 310 and 320. The stage manager panel 340 additionally includes the options “Add logo to stage view” and “Auto add logo to video feeds.”

Referring back to FIG. 1, the host may make a selection on endpoint device 120-1 to add one or more of the graphical elements to content in the online communication session. In one embodiment, the host may select to add the graphical elements to the stage view. In another embodiment, the host may select to add the graphical elements to video feeds of participants in the online communication session. The host may additionally select an option to sync the stage for everyone in the meeting. In this case, the participants in the online communication session are able to view the graphical elements associated with Company A and Company B in the location selected by the host.

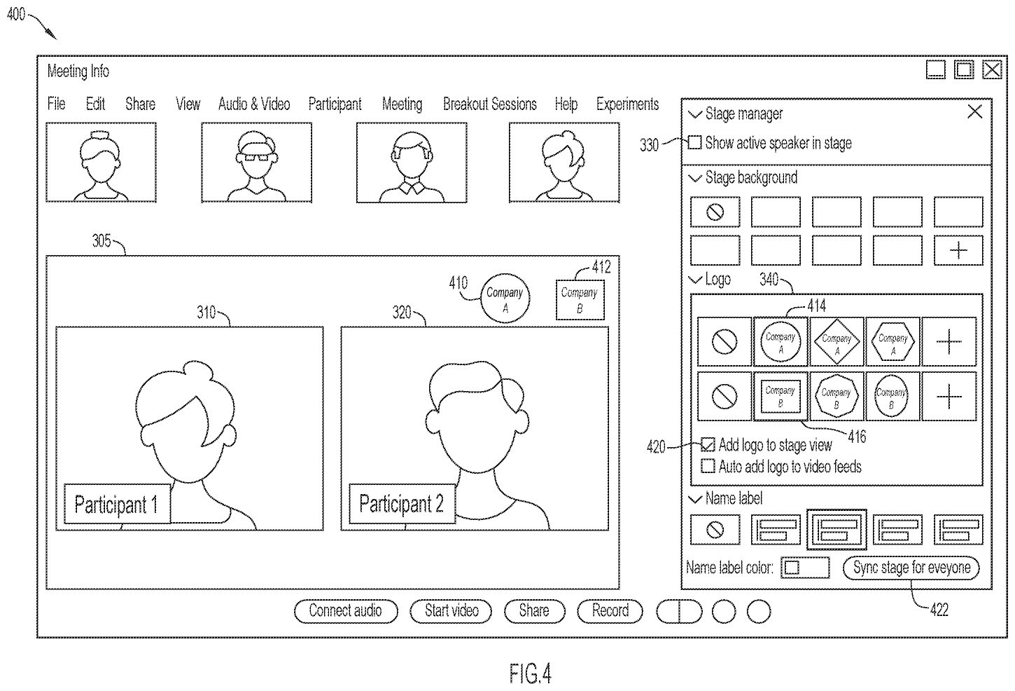

Reference is now made to FIG. 4. FIG. 4 illustrates a user interface 400 in which the host has selected an option to add the logos to the stage view.

As illustrated in FIG. 4, the host has selected a box 420 associated with an option to add logos to the stage view. The host additionally has selected graphical element 414 corresponding to Company A and graphical element 416 corresponding to Company B. In the example illustrated in FIG. 4, graphical element 410 (which corresponds to the selected graphical element 414) and graphical element 412 (which corresponds to the selected graphical element 416) have been added to stage 305. In this example, graphical elements 410 and 412 have been added to the upper right corner of stage 305. In another example, the graphical elements may be added to another location in stage 305. In some embodiments, the host may change one or more locations for the graphical elements (e.g., by dragging and dropping the graphical elements, choosing a location from a menu, etc.). In other embodiments, the graphical elements may be placed in a location on the stage 305 where they may best be seen. For example, if a graphical element includes light colors, the graphical element may be placed in a dark location of the stage 305 where the graphical element may stand out.

The host may additionally select option 422 to sync the stage for everyone. When the host selects this option, the participants of the online communication session may view the stage 305 with the video feeds of Participant 1 and Participant 2 and the graphical elements 410 and 412 in the upper right corner of the stage 305.

Although FIG. 4 shows that graphical elements have been selected for both Company A and Company B, a selection to display no graphical element may be selected for one or more of the domain names. In this example, if a selection to display no graphical element has been selected for one of the domain names, only one of the graphical elements will be displayed in the stage 305. For example, if graphical element 414 is selected and an option to display no graphical element for Company B is selected, graphical element 410 will be displayed in stage 305 and graphical element 412 will not be displayed.

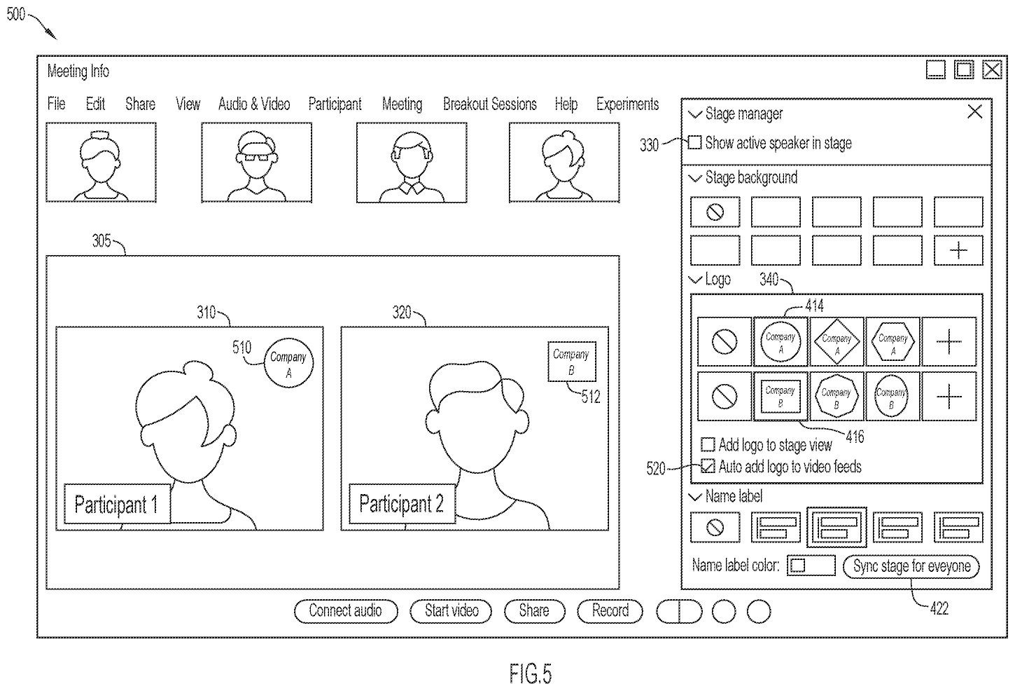

Reference is now made to FIG. 5. FIG. 5 illustrates a user interface 500 in which the host has selected an option to automatically add logos to video feeds.

As illustrated in FIG. 5, the host has selected a box 520 corresponding to an option to automatically add logos to video feeds. The host additionally has selected graphical element 414 corresponding to Company A and graphical element 416 corresponding to Company B. The graphical elements for domain names are automatically added to the video feeds of participants corresponding to the domain names. In the example illustrated in FIG. 3, video feed 310 of Participant 1 and video feed 320 of Participant 2 have been moved to the stage 305.

As discussed above, Participant 1 has an email address of partcipant1@companya.com and Participant 2 has an email address of participant2@companyb.com. In this example, Participant 1 is associated with the domain name companya.com (which corresponds to Company A) and Participant 2 is associated with the domain name companyb.com (which corresponds to Company B). Therefore, the graphical element 510 corresponding to the selected graphical element 414 with the domain name companya.com is added to the video feed 310 of Participant 1 and the graphical element 512 corresponding to the selected graphical element 416 with the domain name companyb.com is added to video feed 320 of Participant 2.

In this example, graphical elements 510 and 512 are located in the upper right corner of the video feeds 310 and 320. In another example, the graphical elements may be added to another location of video feeds 310 and 320. In some embodiments, the host may change one or more locations for the graphical elements (e.g., by dragging and dropping the graphical elements, choosing a location from a menu, etc.). In other embodiments, the graphical elements may be placed in a location on the video feeds 310 and 320 where they may best be seen. For example, if a graphical element includes light colors, the graphical element may be placed in a dark location of a video feed where the graphical element may stand out. In some embodiments, the graphical elements may be placed in different locations in different video feeds.

The host may additionally select option 422 to sync the stage for everyone. When the host selects this option, the participants of the online communication session may view the stage with the video feed 310 of Participant 1 and the video feed 320 Participant 2. The graphical element 510 may be shown in the upper right corner of video feed 310 and the graphical element 512 may be shown in the upper right corner of video feed 320.

Although FIG. 5 shows that graphical elements have been selected for both Company A and Company B, a selection to display no graphical element may be selected for one of the domain names. In this example, if a selection to display no graphical elements is selected for one of the domain names, only one of the graphical elements will be displayed in the video feeds. For example, if graphical element 414 is selected and an option to display no graphical element for Company B is selected, graphical element 510 will be displayed in video feed 310 and graphical element 512 will not be displayed in video feed 320.

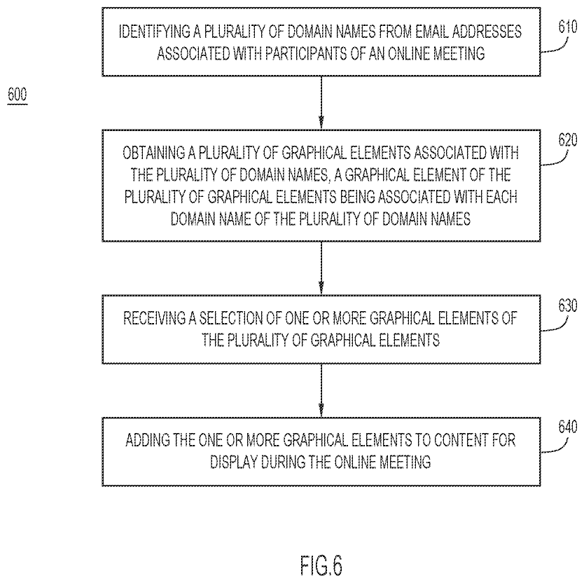

Referring to FIG. 6, FIG. 6 is a flow chart of a method 600 for obtaining and displaying graphical elements corresponding to enterprises associated with participants in an online communication session.

At 610, a plurality of domain names are identified from email addresses associated with participants in an online meeting. The domain names may be associated with companies, organizations, or enterprises associated with the participants.

At 620, a plurality of graphical elements associated with the plurality of domain names are obtained. At least one graphical element of the plurality of graphical elements is associated with each domain name of the plurality of domain names. For example, one or more graphical elements are obtained for each domain name identified from the email addresses. The graphical elements may be, for example, logos or stylized text associated with the domain names. In one embodiment, the graphical elements may be obtained by performing an image search to obtain the graphical elements. In another embodiment, the graphical elements may be obtained from websites associated with the domain names.

At 630, a selection of one or more graphical elements of the plurality of graphical elements is received. For example, a host of the online meeting may select one or more of the graphical elements. In one embodiment, one graphical element may be selected for each domain name. In another embodiment, a graphical element may be selected for at least one of the domain names and no graphical element may be selected for at least another one of the domain names.

At 640, the one or more graphical elements are added to content for display during the online meeting. In one embodiment, the one or more graphical elements may be added to a stage view of the online meeting. In another embodiment, the one or more graphical elements may be added to one or more video feeds of participants of the online meeting. For example, a graphical element associated with a particular domain name may be added to a video feed of a participant with an email address associated with the particular domain name.

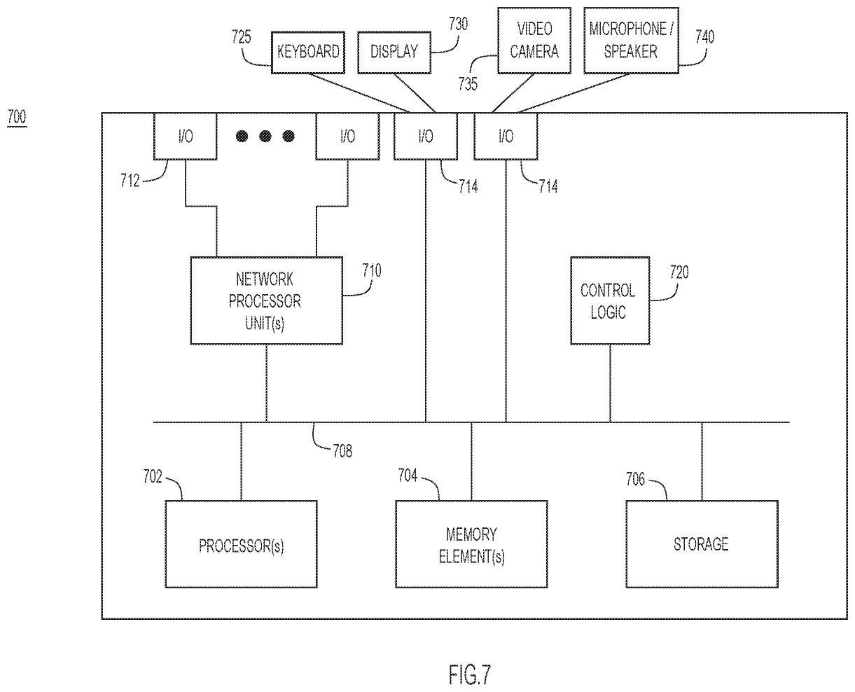

Referring to FIG. 7, FIG. 7 illustrates a hardware block diagram of a computing/computer device 700 that may perform functions of an endpoint device or an end device associated with operations discussed herein in connection with the techniques depicted in FIGS. 1, 2A, 2B, and 3-6. In various embodiments, a computing device, such as computing device 700 or any combination of computing devices 700, may be configured as any devices as discussed for the techniques depicted in connection with FIGS. 1, 2A, 2B, and 3-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computer device 700. For example, I/O interface(s) 714 may provide a connection to external devices such as a keyboard 725, keypad, a touch screen, and/or any other suitable input and/or output device now known or hereafter developed. This may be the case, in particular, when the computer device 700 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as display 730 shown in FIG. 7, particularly when the computer device 700 serves as a user device as described herein. Display 730 may have touch-screen display capabilities. Additional external devices may include a video camera 735 and microphone/speaker combination 740. While FIG. 7 shows the display 730, video camera 735 and microphone/speaker combination 740 as being coupled via one of the I/O interfaces 714, it is to be understood that these components may instead be coupled to the bus 708.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

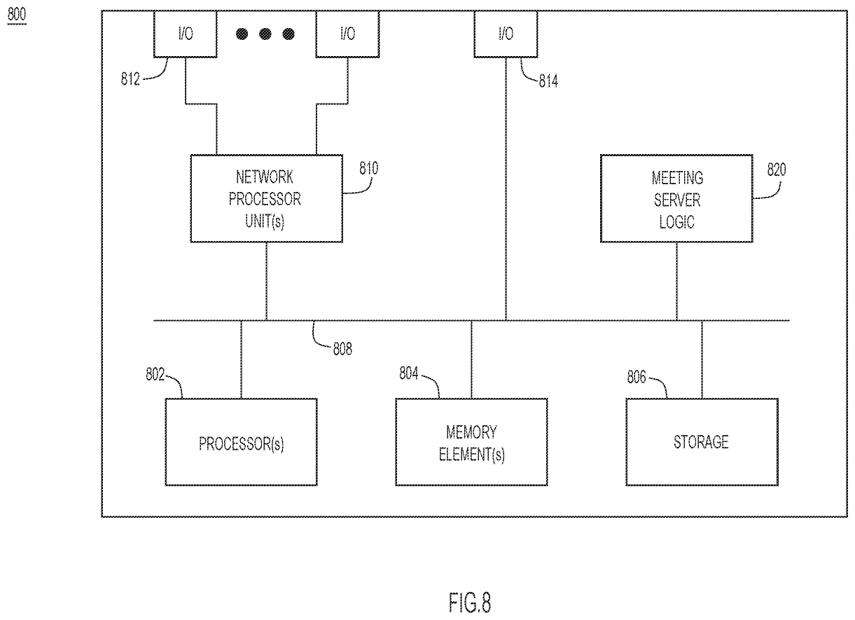

FIG. 8 illustrates a block diagram of a computing device 800 that may perform the functions of the meeting server(s) 110 described herein. The computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and meeting server logic 820. In various embodiments, instructions associated with the meeting server logic 820 is configured to perform the meeting server operations described herein, including those depicted by the flow chart for method 600 shown in FIG. 6.

In one form, a method is provided including: identifying a plurality of domain names from email addresses associated with participants of an online meeting; obtaining a plurality of graphical elements associated with the plurality of domain names, at least one graphical element of the plurality of graphical elements being associated with each domain name of the plurality of domain names; receiving a selection of one or more graphical elements of the plurality of graphical elements; and adding the one or more graphical elements to content for display during the online meeting.

In one example, obtaining the plurality of graphical elements includes performing an image search to obtain the plurality of graphical elements. In another example, obtaining the plurality of graphical elements includes obtaining the plurality of graphical elements from websites associated with the plurality of domain names. In another example, the plurality of graphical elements includes stylized names or logos associated with respective ones of the plurality of domain names. In another example, the plurality of graphical elements are stored at a data store associated with a host of the online meeting.

In another example, receiving the selection of the one or more graphical elements includes receiving the selection from a user device associated with the host of the online meeting. In another example, adding the one or more graphical elements to the content includes: receiving a selection of an option to add the one or more graphical elements to a stage view of the online meeting; and adding the one or more graphical elements to the stage view of the online meeting. In another example, adding the one or more graphical elements to the content includes: receiving a selection of an option to add the one or more graphical elements to one or more video feeds of participants in the online meeting; and adding the one or more graphical elements to the one or more video feeds of participants in the online meeting based on domain names of email addresses associated with the participants.

In another form, an apparatus is provided including: a memory; a network interface configured to enable network communication; and a processor, wherein the processor is configured to perform operations including: identifying a plurality of domain names from email addresses associated with participants of an online meeting; obtaining a plurality of graphical elements associated with the plurality of domain names, at least one graphical element of the plurality of graphical elements being associated with each domain name of the plurality of domain names; receiving a selection of one or more graphical elements of the plurality of graphical elements; and adding the one or more graphical elements to content for display during the online meeting.

In yet another form, one or more non-transitory computer readable storage media encoded with instructions are provided that, when executed by a processor, cause the processor to execute a method including: identifying a plurality of domain names from email addresses associated with participants of an online meeting; obtaining a plurality of graphical elements associated with the plurality of domain names, a graphical element of the plurality of graphical elements being associated with each domain name of the plurality of domain names; receiving a selection of one or more graphical elements of the plurality of graphical elements; and adding the one or more graphical elements to content for display during the online meeting.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
identifying a plurality of domain names from email addresses associated with participants of an online meeting;
obtaining a plurality of graphical elements associated with the plurality of domain names, at least one graphical element of the plurality of graphical elements being associated with each domain name of the plurality of domain names;
receiving a selection of one or more graphical elements of the plurality of graphical elements; and
adding the one or more graphical elements to content for display during the online meeting.

2. The method of claim 1, wherein obtaining the plurality of graphical elements includes performing an image search to obtain the plurality of graphical elements.

3. The method of claim 1, wherein obtaining the plurality of graphical elements includes obtaining the plurality of graphical elements from websites associated with the plurality of domain names.

4. The method of claim 1, wherein the plurality of graphical elements includes stylized names or logos associated with respective ones of the plurality of domain names.

5. The method of claim 1, wherein the plurality of graphical elements are stored at a data store associated with a host of the online meeting.

6. The method of claim 5, wherein receiving the selection of the one or more graphical elements includes receiving the selection from a user device associated with the host of the online meeting.

7. The method of claim 1, wherein adding the one or more graphical elements to the content includes:
receiving a selection of an option to add the one or more graphical elements to a stage view of the online meeting; and
adding the one or more graphical elements to the stage view of the online meeting.

8. The method of claim 1, wherein adding the one or more graphical elements to the content includes:
receiving a selection of an option to add the one or more graphical elements to one or more video feeds of participants in the online meeting; and
adding the one or more graphical elements to the one or more video feeds of participants in the online meeting based on domain names of email addresses associated with the participants.

9. An apparatus comprising:
a memory;
a network interface configured to enable network communication; and
a processor, wherein the processor is configured to perform operations comprising:
identifying a plurality of domain names from email addresses associated with participants of an online meeting;
obtaining a plurality of graphical elements associated with the plurality of domain names, at least one graphical element of the plurality of graphical elements being associated with each domain name of the plurality of domain names;
receiving a selection of one or more graphical elements of the plurality of graphical elements; and
adding the one or more graphical elements to content for display during the online meeting.

10. The apparatus of claim 9, wherein, when obtaining the plurality of graphical elements, the processor is further configured to perform operations comprising performing an image search to obtain the plurality of graphical elements.

11. The apparatus of claim 9, wherein, when obtaining the plurality of graphical elements, the processor is further configured to perform operations comprising obtaining the plurality of graphical elements from websites associated with the plurality of domain names.

12. The apparatus of claim 9, wherein the plurality of graphical elements are stylized names or logos associated with respective ones of the plurality of domain names.

13. The apparatus of claim 9, wherein the plurality of graphical elements are stored at a data store associated with a host of the online meeting.

14. The apparatus of claim 9, wherein, when adding the one or more graphical elements to the content, the processor is further configured to perform operations comprising:
receiving a selection of an option to add the one or more graphical elements to a stage view of the online meeting; and
adding the one or more graphical elements to the stage view of the online meeting.

15. The apparatus of claim 9, wherein, when adding the one or more graphical elements to the content, the processor is further configured to perform operations comprising:
receiving a selection of an option to add the one or more graphical elements to one or more video feeds of participants in the online meeting; and
adding the one or more graphical elements to the one or more video feeds of participants in the online meeting based on domain names of email addresses associated with the participants.

16. One or more non-transitory computer readable storage media encoded with instructions that, when executed by a processor, cause the processor to execute a method comprising:
identifying a plurality of domain names from email addresses associated with participants of an online meeting;
obtaining a plurality of graphical elements associated with the plurality of domain names, a graphical element of the plurality of graphical elements being associated with each domain name of the plurality of domain names;
receiving a selection of one or more graphical elements of the plurality of graphical elements; and
adding the one or more graphical elements to content for display during the online meeting.

17. The one or more non-transitory computer readable storage media of claim 16, wherein obtaining the plurality of graphical elements further comprises performing an image search to obtain the plurality of graphical elements or obtaining the plurality of graphical elements from websites associated with the plurality of domain names.

18. The one or more non-transitory computer readable storage media of claim 16, wherein the plurality of graphical elements are stylized names or logos associated with respective ones of the plurality of domain names.

19. The one or more non-transitory computer readable storage media of claim 16, wherein the plurality of graphical elements are stored at a data store associated with a host of the online meeting.

20. The one or more non-transitory computer readable storage media of claim 16, wherein adding the one or more graphical elements to the content includes adding the one or more graphical elements to a stage view of the online meeting or adding the one or more graphical elements to one or more video feeds of participants in the online meeting based on domain names of email addresses associated with the participants.
